(19) United States
(12) Patent Application Publication
(10) Pub. No.: US 2018/0100562 A1
(43) Pub. Date: Apr. 12, 2018

(54) SPEED REDUCER COMPRISING TWO INTERMEDIATE TRANSMISSION LINES

(71) Applicant: Safran Transmission Systems, Colombes (FR)

(72) Inventors: Guillaume BECK, Moissy-Cramayel (FR); Benjamin FERAUD, Moissy-Cramayel (FR)

(21) Appl. No.: 15/560,125

(22) PCT Filed: Mar. 25, 2016
(86) PCT No.: PCT/FR2016/050694

§ 371 Date: Sep. 20, 2017

(30) Foreign Application Priority Data
Mar. 27, 2015 (FR) 1552581

(51) Int. Cl. F16H 1/22; F02C 7/36

(52) U.S. Cl. CPC F16H 1/22; F05D 2260/15; F05D 2260/4031; F02C 7/36

(57) ABSTRACT

The invention relates to a speed reducer having two intermediate transmission lines (4, 5) in particular for a turbine engine, comprising an input line (2) and an output line (3) driven by the input line by means of said intermediate lines, said intermediate lines being substantially in parallel with an axis (B) of rotation of the input line (2), said reducer further comprising means for distributing loads between the intermediate lines (4, 5), characterised in that said distribution means comprise a pinion (7) which is rigidly connected to a shaft (6) of the input line, the input line being movable in translation along said axis (B) and comprising two rings having helical external teeth (7a, 7b), the helices of which are oriented in opposite directions, each cooperating respectively with a pinion (12, 13) of an intermediate line (4, 5). The invention also relates to a turbine engine comprising such a speed reducer and to a method for distributing the loads in such a reducer.

### TECHNICAL FIELD

The present invention relates to a speed reducer having two intermediate transmission lines, in particular for a turbine engine.

### PRIOR ART

A turbine engine can comprise one or more mechanical speed reducers. This is the case in particular with a turboprop engine, the propeller of which is set into rotation by a turbine shaft by means of a speed reducer.

There are several types of speed reducer, such as epicyclic train reducers, chain reducers, endless screw reducers, and reducers having intermediate transmission lines, etc. The present invention essentially relates to a reducer having intermediate transmission lines (also referred to as a compound reducer).

In the current art, a speed reducer of this type comprises an input line and an output line driven by the input line by means of two intermediate transmission lines. The power transmitted by the input line is separated between the intermediate lines before being transferred to the output line. The intermediate transmission lines are in parallel and generally each comprise a shaft supporting an input pinion meshed with the input line and an output pinion meshed with the output line. By varying the number of teeth of the different pinions, it is possible to obtain a reduction ratio between the input line and the output line. This architecture allows a significant reduction in speed in a confined space and with a controlled mass.

By definition, a reducer of this type is a hyperstatic system. Without any special arrangements, it is possible for an intermediate line to pass the majority of the engine power, whilst the other intermediate line passes practically no power.

### SUMMARY OF THE INVENTION

The present invention proposes in particular joining means for distributing loads to a reducer of this type in order to get closer to an equal distribution of the power between the two intermediate lines.

In particular, the invention is achieved by a speed reducer having two intermediate transmission lines, in particular for a turbine engine, comprising an input line and an output line driven by the input line by means of said intermediate lines, said intermediate lines being substantially in parallel with an axis of rotation of the input line, said reducer further comprising means for distributing loads between the intermediate lines, characterised in that said distribution means comprise a pinion which is rigidly connected to a shaft of the input line, the input line being movable in translation along said axis and comprising two rings having helical external teeth, the helices of which are oriented in opposite directions, each cooperating respectively with a pinion of an intermediate line.

In a known manner, the transmission of torques by gear units having helical teeth produces axial forces, which are substantially proportional to the transmitted torques. The helices of the teeth of the two rings are oriented in opposite directions, and the axial forces exerted on the input line by the intermediate lines are in opposite directions respectively. The force resulting from these axial forces moves the input line towards the pinion of the secondary line to which the lowest torque is transmitted. This movement, being carried out in the opposite direction to the lowest force, rebalances the play for the intermediate line in question and rebalances the transmitted torques. In this way, the axial movement of the pinion at the same time as the input line automatically rebalances the torques transmitted to the intermediate lines.

According to different variants of the invention, which can be taken together or separately:
said pinions connected to the intermediate lines are translationally fixed in parallel with the axis;
the two rings having helical external teeth have tilt angles of the helix which are substantially equal in absolute value;
the two rings having helical external teeth have the same diameter;
the two rings having helical external teeth are joined so as to form chevrons;
the two rings having helical external teeth have substantially the same extension along the axis of rotation; the axial extension of the pinion allows the movement of only one element so as to provide a simple, efficient and stable solution;
the helix of each ring having helical external teeth is oriented in such a way that, during the transmission of a torque, an axial force is exerted on said ring by the pinion connected to the corresponding intermediate line, in the direction of the other ring having helical external teeth.

The invention also relates to a turbine engine comprising at least one such speed reducer.

The invention also relates to a method for transmitting a rotational torque, in particular in a turbine engine, by means of a speed reducer comprising an input line, two intermediate transmission lines, and an output line driven by the input line by means of said intermediate lines, the intermediate lines being substantially in parallel with an axis of rotation of the input line, the method consisting in adjusting the axial position of the input line, along said axis, so as to equalise the loads between the two intermediate lines. Preferably, the adjustment of the axial position of the input line is carried out automatically by the reducer and results from an equalisation of the torques transmitted by the input line to each of the intermediate lines.

### DESCRIPTION OF THE DRAWINGS

The invention will be better understood, and other details, features and advantages of the invention will become clearer upon reading the following description, given by way of non-limiting example with reference to the accompanying drawings, in which:

FIG. 1 is a very schematic side view of a speed reducer having two intermediate transmission lines,

FIG. 2 is a very schematic front view of a speed reducer having two intermediate transmission lines,

FIGS. 3 and 4 are schematic partial and top views of a reducer of the above-mentioned type according to the invention, FIG. 3 showing a non-uniform distribution of the loads between the intermediate lines, and FIG. 4 showing a uniform distribution of the loads between the intermediate lines, and

FIG. 5 is a very schematic axial sectional half view of an input line equipped with means for distributing loads according to the invention.

### DETAILED DESCRIPTION

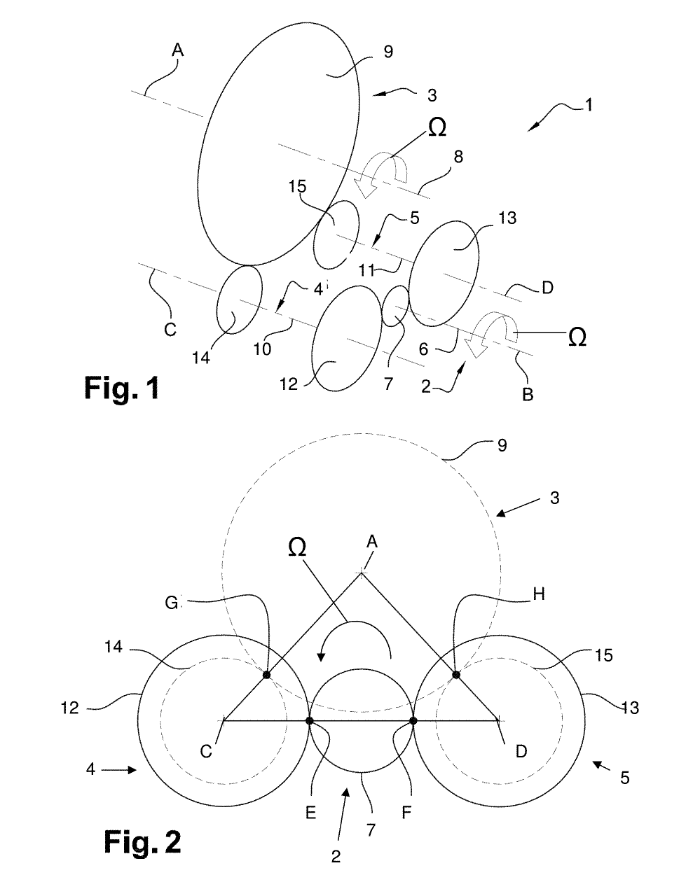

FIG. 1 shows, very schematically, a speed reducer 1 having two intermediate transmission lines, said reducer 1 essentially comprising four parts: an input line 2, an output line 3 and two intermediate transmission lines 4, 5 which are driven by the input line 2 and in turn drive the output line 3.

The different parts 2, 3, 4, 5 of the reducer 1 are generally mounted in a housing of the reducer (not shown here), said housing comprising a first opening for the passage of the input line 2 and the connection thereof to a first element of a turbine engine for example, and a second opening for the passage of the output line 3 and the connection thereof to a second element of the turbine engine. The first element is for example a turbine shaft of the turbine engine, and the second element is a shaft for driving a propeller of said turbine engine when said engine is a turboprop engine.

The input line 2 comprises a shaft 6 supporting a pinion 7 having external teeth. The pinion 7 and the shaft 6 are coaxial and rotate about the same axis, marked B. In the example shown, the pinion and the shaft are driven in the direction of rotation Ω, counterclockwise, by the turbine engine shaft.

The output line 3 comprises a shaft 8 supporting a pinion 9 having external teeth. The pinion 9 and the shaft 8 are coaxial and rotate about the same axis, marked A. In this case, the pinion and the shaft rotate in the same direction of rotation U as the pinion 7 and the shaft 6 of the input line 2, but at a different speed.

The input and output lines 2, 3 are in parallel. The axes of rotation B, A thereof are thus in parallel.

The intermediate transmission lines 4, 5 are substantially in parallel. Each line 4, 5 comprises a shaft 10, 11 which supports an input pinion 12, 13 at a first end and an output pinion 14, 15 at a second end. The output pinions 14, 15 are meshed with the pinion 9 of the output line 3. The input pinions 12, 13 are meshed with the pinion 7 of the input line 2. The pinions 12, 13, 14, 15 have external teeth. Each shaft 10, 11 and the pinions 12, 13, 14, 15 thereof are coaxial and rotate about the same axis, marked C, D, which is in parallel with the axes A and B. They rotate in a direction of rotation which is inverse to that Ω of the shaft 6 of the input line 2. In this case, the rotational speeds thereof are substantially the same, the pinions 13, 14 respectively having the same diameter ratios with corresponding rings having helical external teeth 7a, 7b on the pinion 7.

As explained above, this type of reducer 1 is a hyperstatic system, and it is possible for an intermediate line, for example 10, to pass the majority of the engine power, whilst the other intermediate line 11 passes practically no power. This poor distribution of power or loads can be due to the play between the gear units. For example, as can be seen in FIG. 2, although the pinions 14, 15 are in contact at the points G, H with the pinion 9, and the pinion 12 of one of the intermediate lines 4 is in contact at the point E with the pinion 7, it is difficult to ensure that there is no play at F between the pinion 7 and the pinion 13 of the other intermediate line 5.

The invention proposes a solution to this problem by equipping the reducer 1 with means for distributing loads between the intermediate lines 4, 5.

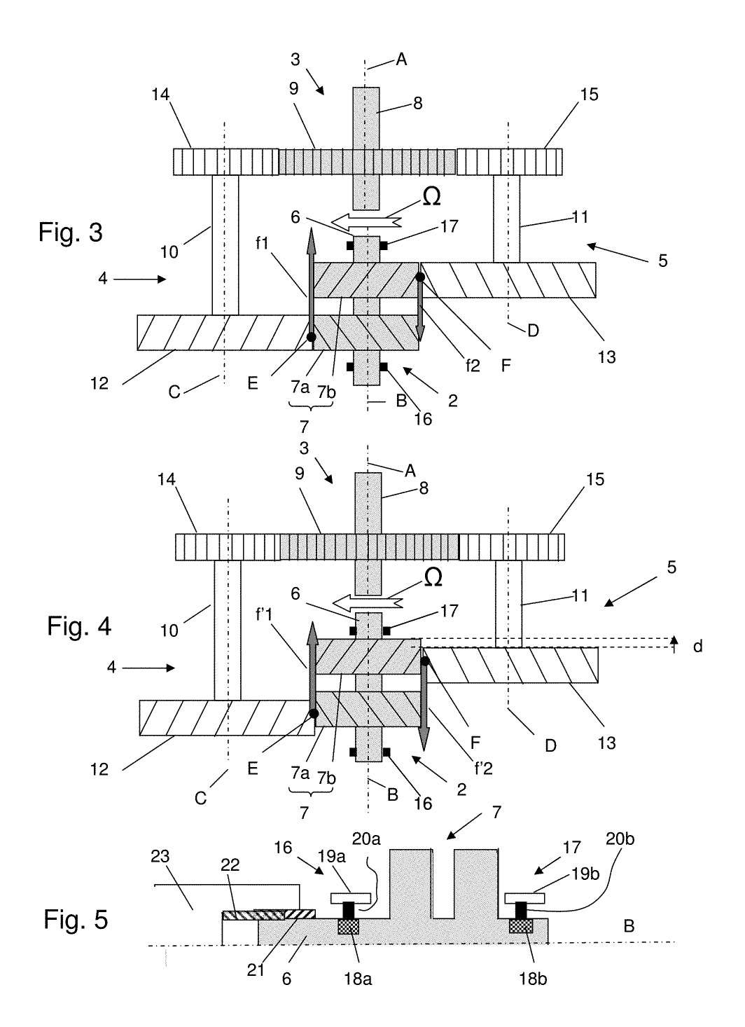

The general principle of the invention is shown in FIGS. 3 and 4. According to the invention, the pinion 7 comprises a first and a second ring 7a, 7b having helical external teeth and the axis B as an axis of revolution, each ring meshing respectively with the pinions 12, 13 of the intermediate lines 10, 11, said lines being respectively on the left and on the right in the drawings. In addition, the winding directions of the helices of the teeth of the two rings 7a, 7b are opposing.

In this case, the two rings having helical teeth 7a, 7b are cylindrical, in other words the teeth are formed on a cylinder. In addition, the two rings having teeth 7a, 7b have the same diameter. As a result, it is not necessary to provide axial movement of the pinions of the intermediate lines, or of the intermediate lines to allow contact with the teeth of the pinions of the intermediate lines.

The pinions 12, 13 of the intermediate lines 4, 5 also have helical external teeth, at a pitch and a winding direction of the helix which are suitable for cooperating with the corresponding ring having helical teeth 7a, 7b.

In a known manner, the operation of the gear units having helical teeth creates an axial force varying in a manner which is substantially proportional to the transmitted torque. In the example shown, with reference to FIG. 3, for the direction of rotation Ω of the shaft 6 corresponding to that indicated in FIG. 1, the transmission of a torque to the left intermediate transmission line 4 creates an axial force f1, which is directed upwards and is applied in the region of the contact E of the first ring 7a with the pinion 12, whilst the transmission of a torque to the right intermediate transmission line 5 creates an axial force f2, which is directed downwards and is applied in the region of the contact F of the second ring 7b with the pinion 13.

According to a second aspect of the invention, shown in FIG. 4, in this case, the pinion 7 is movable along the axis B of the input line 2, in relation to the housing of the reducer 1 (not shown). As for the pinions 12, 13 of the intermediate lines 4, 5, they are fixed in relation to the housing. In the example shown, the pinion 7 is rigidly connected to the shaft 6, and bearings 16, 17 placed axially on either side of the pinion 7 keep the shaft 6 centred on the axis B of the input line whilst allowing the shaft to move axially.

For example, with reference to FIG. 5, the inner ring 18a, 18b of each bearing 16, 17 is rigidly connected to the shaft 6, whereas the outer ring 19a, 19b is fixed in relation to the housing (not shown). By way of example, the outer ring 19a, 19b is smooth, and the rolling elements, preferably rollers 20a, 20b, allow axial movements of the inner ring 18a, 18b by sliding axially in the outer ring 19a, 19b.

For the transmission of the torque to the input line 2 of the reducer, the end of the shaft 6 comprises for example grooves 21 engaged in grooves 22 which are complementary to a sleeve 23 for connecting the input line 2 of the reducer 1 to the turbine shaft (not shown). The grooves also allow the pinion 7 to be movable in relation to the turbine shaft. This axial freedom can also be ensured by an additional flexible element.

With reference to FIG. 3, if one of the intermediate lines, for example the left line 4, has a greater load, that means that the torque passing through said intermediate line 4 is greater than on the other intermediate line 5, and therefore the force f1 produced by the left intermediate line 4 on the pinion 7 of the input line 2 is greater than that f2 produced by the right intermediate line 5. This generates an axial resulting force which is oriented upwards and applied to the pinion 7 of the input line 2, and this causes an axial movement of the input line 2 upwards, in the direction of the right pinion 13, on which the lowest torque is exerted.

This movement makes it possible to rebalance the play in the region of the input line. In the example shown, if the force f2 exerted by the pinion 13 of the right intermediate line 5 is less than that of the left intermediate line 4, the pinion 7 of the input line 2 will move upwards and thus press the teeth of the second helical ring 7a against those of the right pinion 13, allowing the pinion 7 to transmit a higher torque to the right intermediate line 5. With reference to FIG. 4, at equilibrium, the forces f1′, f2 on the pinion 7 due to the torques on the intermediate lines 4, 5 cancel one another out, meaning that the torques transmitted to the intermediate lines 4, 5 are equal.

In the example shown, the rings 7a, 7b of the pinion 7 of the input line are at a distance from one another axially, and the teeth of said rings have substantially the same axial extension. However, this example is non-limiting. In particular, the two rings having helical teeth can be joined and thus form a single set of teeth in chevrons on the input pinion 7. The pinions 12, 13 of the intermediate lines 4, 5 can also be slightly offset in relation to the rings having teeth 7a, 7b and/or can be narrower axially, in such a way that the movement of the input line 2 does not place them in contact with the ring having teeth 7a, 7b cooperating with the pinion of the other intermediate line.

According to another advantage of the invention, as can be seen in FIG. 4, the application points E, F of the axial forces f1, f2 are offset axially. They thus create a torque along an axis which is perpendicular to the axis B of the input line 2. The forces produced by said torque are captured in the region of the bearings 17, 18, and this makes it possible to load the rolling bearings. Problems relating to the rolling elements 20a, 20b sliding in the bearings 17, 18 are thus avoided.

The example implementation shown is non-limiting, in particular with regard to the geometric characteristics of the pinions 7, 12, 13 involved in the process of distributing the loads, and with regard to the ratios of torques transmitted to each intermediate line 4, 5 by the input line 2. This example shows a method for transmitting a rotational torque, by means of a speed reducer 1 of the compound type, consisting in adjusting the axial position of the input line 2 so as to equalise the loads between the two intermediate lines 4, 5. In such a method, the axial movement d of the input line 2 results from equalising the torques transmitted by the input line 2 to each of the intermediate lines 4, 5. This is made possible in particular by the existence of an axial force f1, f2 exerted on the input line 2 by each intermediate line 4, 5, increasing in accordance with the torque that is transmitted and that is oriented differently for each intermediate line, respectively, whereas said transmitted torque is an increasing function of the axial movement d of the input line 2 in the opposite direction to said axial force f1, f2.

1. Turbine engine comprising at least one speed reducer, said speed reducer having two intermediate transmission lines, in particular for a turbine engine, comprising an input line and an output line driven by the input line by means of said intermediate lines, said intermediate lines being substantially in parallel with an axis B of rotation of the input line, said speed reducer further comprising distributing loads means between the intermediate lines, wherein said distribution loads means comprise a pinion which is rigidly connected to a shaft of the input line, the input line being movable in translation along said axis and comprising two rings having helical external teeth, the helices of which are oriented in opposite directions, each cooperating respectively with a pinion of an intermediate line.

2. Turbine engine according to claim 1, wherein said pinions connected to the intermediate lines are translationally fixed in parallel with the axis B.

3. Turbine engine according to claim 1, wherein the two rings having helical external teeth have tilt angles of the helix which are substantially equal in absolute value.

4. Turbine engine according to claim 1, wherein the two rings having helical external teeth have the same diameter.

5. Turbine engine according to claim 4, wherein the two rings having helical external teeth are joined so as to form chevrons.

6. Turbine engine according to claim 1, wherein the two rings having helical external teeth have substantially the same extension along the axis of rotation B.

7. Turbine engine according to claim 1, wherein the helix of each ring having helical external teeth is designed in such a way that, during the transmission of a torque, an axial force is exerted on said ring by the pinion connected to the corresponding intermediate line, in the direction of the other ring having helical external teeth.

8. (canceled)

9. Method for transmitting a rotational torque, in a turbine engine, by means of a speed reducer comprising an input line, two intermediate transmission lines, and an output line driven by the input line by means of said intermediate lines, the intermediate lines being substantially in parallel with an axis B of rotation of the input line, the method consisting in adjusting the axial position of the input line, along said axis, so as to equalise the loads between the two intermediate lines.

10. Method for transmitting a rotational torque according to claim 9, wherein the adjustment of the axial position of the input line is carried out automatically by the reducer and results from an equalisation of the torques transmitted by the input line to the intermediate lines respectively.
